(19) United States
(12) Patent Application Publication
(10) Pub. No.: US 2014/0158236 A1
(43) Pub. Date: Jun. 12, 2014

(54) HYDRAULIC PRESSURE SUPPLY SYSTEM OF AUTOMATIC TRANSMISSION

(71) Applicant: Hyundai Motor Company, Seoul (KR)

(72) Inventors: Se Hwan JO, Bucheon-si (KR); Jin Young HWANG, Busan (KR); Taehwan WI, Bucheon-si (KR)

(73) Assignee: Hyundai Motor Company, Seoul (KR)

(21) Appl. No.: 14/093,825

(22) Filed: Dec. 2, 2013

(30) Foreign Application Priority Data
Dec. 12, 2012 (KR) 10-2012-0144823

(51) Int. Cl. F16H 61/00

(52) U.S. Cl. CPC F16H 61/0021
USPC 137/565.13

(57) ABSTRACT

A hydraulic pressure supply system of an automatic transmission for a vehicle may include a low-pressure hydraulic pump receiving oil stored in an oil pan through an input line, generating low hydraulic pressure using the oil, and supplying the low hydraulic pressure to a low pressure portion through a low-pressure line, and a high-pressure hydraulic pump increasing a portion of the low hydraulic pressure to high hydraulic pressure and supplying the high hydraulic pressure to a high pressure portion through a high-pressure line.

### CROSS-REFERENCE TO RELATED APPLICATION

The present application claims priority of Korean Patent Application Number 10-2012-0144823 filed Dec. 12, 2012, the entire contents of which application is incorporated herein for all purposes by this reference.

### BACKGROUND OF INVENTION

1. Field of Invention

The present invention relates to a hydraulic pressure supply system of an automatic transmission for a vehicle. More particularly, the present invention relates to a hydraulic pressure supply system of an automatic transmission for a vehicle that can control an electric motor with optimized rotation speed by detecting whether target hydraulic pressure is formed at a high pressure portion and a low pressure portion.

2. Description of Related Art

Recently, vehicle makers direct all their strength to improve fuel economy due to worldwide high oil prices and strengthen of exhaust gas regulations.

Improvement of fuel economy may be achieved by minimizing unnecessary power consumption of a hydraulic pump.

A recent automatic transmission is provided with a low-pressure hydraulic pump and a high-pressure hydraulic pump so as to improve fuel economy. Therefore, hydraulic pressure generated by the low-pressure hydraulic pump is supplied to a low pressure portion (i.e., a torque converter, a cooling device, and a lubrication device), and hydraulic pressure generated by the high-pressure hydraulic pump is supplied to a high pressure portion (i.e., friction members selectively operated when shifting).

General hydraulic pressure of the automatic transmission is generated for the low pressure portion (i.e., generated by the low-pressure hydraulic pump), and hydraulic pressure demanded by the high pressure portion is generated by the high-pressure hydraulic pump and then is supplied to the high pressure portion.

FIG. 1 is a schematic diagram of a conventional hydraulic pressure supply system of an automatic transmission for a vehicle.

Referring to FIG. 1, a conventional hydraulic pressure supply system is adapted to supply low hydraulic pressure generated by a low-pressure hydraulic pump 2 to a low pressure portion 4 such as a torque converter (T/C), a cooling portion, and a lubrication portion, and to supply high hydraulic pressure generated by a gh-pressure hydraulic pump 6 to a high pressure portion 8 for operating friction members related to shifting.

The hydraulic pressure generated by the low-pressure hydraulic pump 2 is controlled to be stable hydraulic pressure at a low-pressure regulator valve 10 and is then supplied to the low pressure portion 4, and the low-pressure regulator valve 10 is controlled by control pressure of a first solenoid SOL1.

If the high-pressure hydraulic pump 6 increases the low hydraulic pressure supplied from the low-pressure hydraulic pump 2 to high hydraulic pressure, and the hydraulic pressure increased by the high-pressure hydraulic pump 6 is controlled to be stable hydraulic pressure by a high-pressure regulator valve 12 and is then supplied to the high pressure portion 8.

In addition, a first hydraulic pressure sensor S1 for detecting the hydraulic pressure is disposed on a low-pressure line 14 connecting the low-pressure hydraulic pump 2 to the low-pressure regulator valve 10, and a second hydraulic pressure sensor S2 for detecting the hydraulic pressure is disposed on a high-pressure line 16 connecting the high-pressure hydraulic pump 6 to the high-pressure regulator valve 12.

Therefore, a rotation speed of the low-pressure electric motor M1 is controlled according to a signal detected by the first hydraulic pressure sensor S1, and a rotation speed of the high-pressure electric motor M2 is controlled according to a signal detected by the second hydraulic pressure sensor S2.

Since the first and second hydraulic pressure sensors S1 and S2 are used for controlling the rotation speeds of the low-pressure and high-pressure electric motors M1 and M2, however, the number of components may increase and manufacturing cost may also increase according to a conventional hydraulic pressure supply system.

In addition, since the first and second hydraulic pressure sensors S1 and S2 do not detect spare hydraulic amount of the low-pressure line 14 and the high-pressure line 16 but detect whether target pressure is reached, the rotation speeds of the electric motors M1 and M2 cannot be controlled optimally.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for a hydraulic pressure supply system of an automatic transmission for a vehicle having advantages of controlling electric motors so as to optimize hydraulic pressure and oil amount at a high pressure portion and a low pressure portion by using information given from one pressure sensor and enhancing control responsiveness.

A hydraulic pressure supply system of an automatic transmission for a vehicle according to one aspect of the present invention may include a low-pressure hydraulic pump receiving oil stored in an oil pan through an input line, generating low hydraulic pressure using the oil, and supplying the low hydraulic pressure to a low pressure portion through a low-pressure line, and a high-pressure hydraulic pump increasing a portion of the low hydraulic pressure to high hydraulic pressure and supplying the high hydraulic pressure to a high pressure portion through a high-pressure line.

The hydraulic pressure supply system may further include: a low-pressure regulator valve controlled by control pressure of a first solenoid valve, and recirculating a portion of the hydraulic pressure supplied through the low-pressure line to the input line through a first recirculation line so as to control the hydraulic pressure; a high-pressure regulator valve controlled by control pressure of a second solenoid valve, and recirculating a portion of the hydraulic pressure supplied through the high-pressure line to the low-pressure line through a second recirculation line so as to control the hydraulic pressure; an orifice disposed on the second recirculation line; a pressure sensor disposed on the second recirculation line and detecting hydraulic pressure; and a transmission control unit controlling at least one electric motor driving the low-pressure hydraulic pump and the high-pressure hydraulic pump according to information detected by the pressure sensor.

The pressure sensor may be disposed between the orifice and the high-pressure regulator valve.

A low-pressure electric motor driving the low-pressure hydraulic pump and a high-pressure electric motor driving the high-pressure hydraulic pump may be provided independently.

The electric motor may drive the low-pressure hydraulic pump and the high-pressure hydraulic pump connected by one shaft simultaneously.

A hydraulic pressure supply system of an automatic transmission for a vehicle according to another aspect of the present invention may generate low hydraulic pressure and high hydraulic pressure using oil stored in an oil pan and may supply the low hydraulic pressure and the high hydraulic pressure respectively to a low pressure portion and a high pressure portion.

The hydraulic pressure supply system may include: a low-pressure hydraulic pump receiving the oil stored in the oil pan through an input line, generating the low hydraulic pressure, discharging the generated low hydraulic pressure to a low-pressure line; a low-pressure regulator valve controlled by control pressure of a first solenoid valve, recirculating a portion of the hydraulic pressure supplied through the low-pressure line to the input line through a first recirculation line so as to control the hydraulic pressure, and supplying the controlled hydraulic pressure to the low pressure portion; a high-pressure hydraulic pump increasing a portion of the hydraulic pressure supplied through the low-pressure line and discharging the high hydraulic pressure to a high-pressure line; a high-pressure regulator valve controlled by control pressure of a second solenoid valve, recirculating a portion of the hydraulic pressure supplied through the high-pressure line to the low-pressure line through a second recirculation line so as to control the hydraulic pressure, and supplying the controlled hydraulic pressure to the high pressure portion; an orifice disposed on the second recirculation line; a pressure sensor disposed on the second recirculation line between the orifice and the high-pressure regulator valve; a low-pressure electric motor driving the low-pressure hydraulic pump according to information detected by the pressure sensor; and a high-pressure electric motor driving the high-pressure hydraulic pump according to information detected by the pressure sensor.

A hydraulic pressure supply system of an automatic transmission for a vehicle according to the other aspect of the present invention may include: a low-pressure hydraulic pump receiving the oil stored in the oil pan through an input line, generating the low hydraulic pressure, discharging the generated low hydraulic pressure to a low-pressure line; a low-pressure regulator valve controlled by control pressure of a first solenoid valve, recirculating a portion of the hydraulic pressure supplied through the low-pressure line to the input line through a first recirculation line so as to control the hydraulic pressure, and supplying the controlled hydraulic pressure to the low pressure portion; a high-pressure hydraulic pump increasing a portion of the hydraulic pressure supplied through the low-pressure line and discharging the high hydraulic pressure to a high-pressure line; a high-pressure regulator valve controlled by control pressure of a second solenoid valve, recirculating a portion of the hydraulic pressure supplied through the high-pressure line to the low-pressure line through a second recirculation line so as to control the hydraulic pressure, and supplying the controlled hydraulic pressure to the high pressure portion; an orifice disposed on the second recirculation line; a pressure sensor disposed on the second recirculation line between the orifice and the high-pressure regulator valve; and an electric motor driving the low-pressure hydraulic pump and the high-pressure hydraulic pump according to information detected by the pressure sensor simultaneously.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of a conventional hydraulic pressure supply system of an automatic transmission.

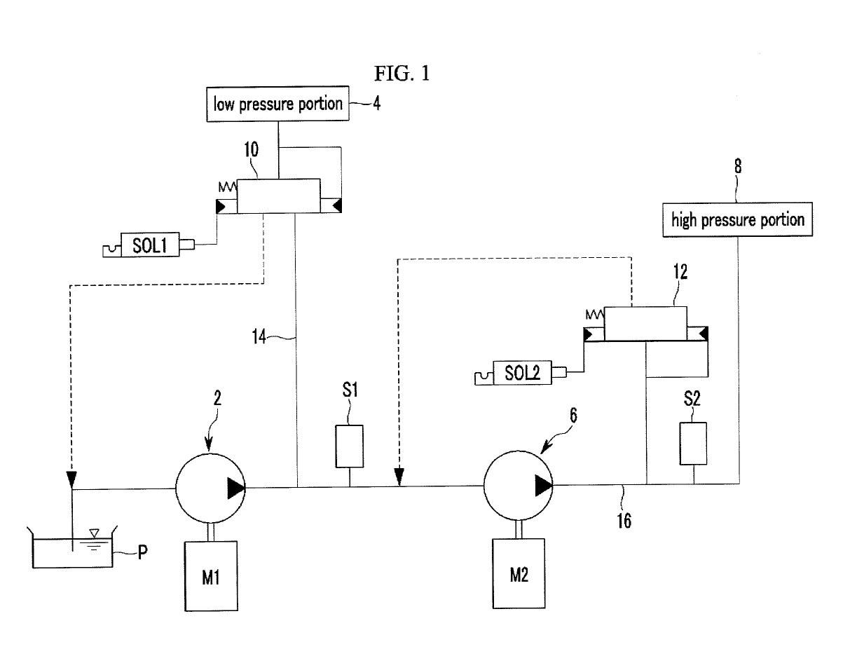

FIG. 2 is a schematic diagram of an exemplary hydraulic pressure supply system of an automatic transmission according to the present invention.

FIG. 3 is a block diagram of the hydraulic pressure supply system of FIG. 2 for controlling electric motors.

FIG. 4 is a schematic diagram of an exemplary hydraulic pressure supply system of an automatic transmission according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Description of components that are not necessary for explaining the illustrated embodiments will be omitted, and the same constituent elements are denoted by the same reference numerals in this specification.

In the detailed description, ordinal numbers are used for distinguishing constituent elements having the same terms, and have no specific meanings.

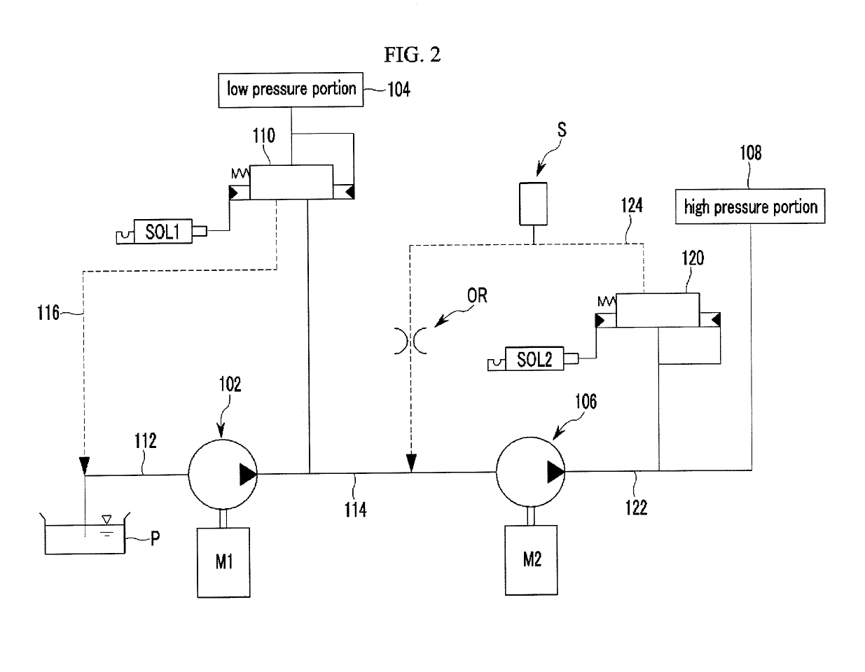

FIG. 2 is a schematic diagram of a hydraulic pressure supply system of an automatic transmission according to various embodiments of the present invention.

Referring to FIG. 2, a hydraulic pressure supply system according to various embodiments of the present invention is adapted to supply low hydraulic pressure generated by a low-pressure hydraulic pump 102 to a low pressure portion 104 such as a torque converter (T/C), a cooling portion, a lubrication portion and to supply high hydraulic pressure generated by a high-pressure hydraulic pump 106 to a high pressure portion 108 for operating friction members related to shifting.

The low hydraulic pressure is a lower pressure facilitating operation of the torque converter (T/C) and cooling and lubrication, and the high hydraulic pressure is a high pressure facilitating operation of a plurality of friction members.

The low-pressure hydraulic pump 102 is driven by a low-pressure electric motor M1, and the high-pressure hydraulic pump 106 is driven by a high-pressure electric motor M2.

The hydraulic pressure generated by the low-pressure hydraulic pump 102 is controlled to be stable hydraulic pressure by a low-pressure regulator valve 110 and is then supplied to the low pressure portion 104. For this purpose, the low-pressure hydraulic pump 102 receives oil stored in an oil pan P through an input line 112, and discharges the low hydraulic pressure to a low-pressure line 114.

The low-pressure regulator valve 110 is controlled by control pressure of the first solenoid valve SOL1 and recirculates a portion of the hydraulic pressure supplied through the low-pressure line 114 to the input line 112 through a first recirculation line 116 so as to control the hydraulic pressure.

The high-pressure hydraulic pump 106 increases a portion of the low hydraulic pressure supplied from the low-pressure hydraulic pump 102 to the high hydraulic pressure, and discharges the high hydraulic pressure to a high-pressure line 122. The hydraulic pressure of the high-pressure line 122 is controlled by a high-pressure regulator valve 120 and is then supplied to the high pressure portion 108.

The high-pressure regulator valve 120 is controlled by control pressure of the second solenoid valve SOL2 and recirculates a portion of the hydraulic pressure supplied through the high-pressure line 122 to the low-pressure line 114 through a second recirculation line 124 so as to control the hydraulic pressure.

The hydraulic pressure supply system of an automatic transmission of FIG. 2 further includes an orifice OR and a pressure sensor S.

The orifice OR is disposed on the second recirculation line 124, and the pressure sensor S is disposed on the second recirculation line 124 between the orifice OR and the high-pressure regulator valve 120.

Therefore, flow amount recirculated to the low-pressure line 114 through the second recirculation line 124 is controlled to be constant by the orifice OR, and thereby the flow amount of the low-pressure line 114 is not substantially changed and becomes stable.

In addition, the flow amount of the second recirculation line 124 is hardly changed and is maintained to be stable. Therefore, the pressure sensor S detects the hydraulic pressure formed by the stable flow amount of the second recirculation line 124 and transmits information thereon to a transmission control unit TCU.

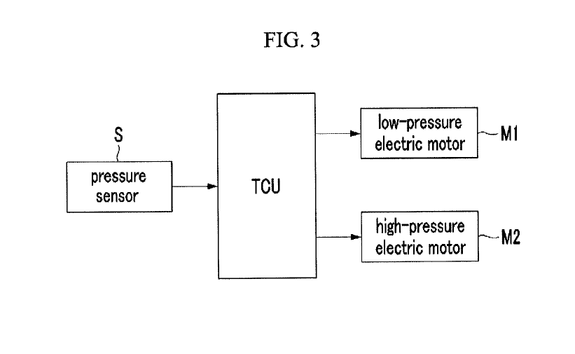

FIG. 3 is a block diagram of a hydraulic pressure supply system of an automatic transmission of FIG. 2 for controlling electric motors.

Referring to FIG. 3, the transmission control unit controls rotation speeds of the low-pressure electric motor M1 and the high-pressure electric motor M2 according to information on the pressure detected by the pressure sensor S.

That is, if the pressure detected by the pressure sensor S is lower than a target hydraulic pressure of the low pressure portion, the rotation speeds of the low-pressure electric motor M1 and the high-pressure electric motor M2 are controlled to increase. If the pressure detected by the pressure sensor S is the same as the target hydraulic pressure of the low pressure portion, the rotation speeds of the low-pressure electric motor M1 and the high-pressure electric motor M2 are controlled to be maintained.

In addition, the pressure detected by the pressure sensor S is the same as the target hydraulic pressure of the low pressure portion +α (pressure margin), the rotation speed of the high-pressure electric motor M2 is controlled to be maintained. If the pressure detected by the pressure sensor S is higher than the target hydraulic pressure of the low pressure portion +α (pressure margin), the rotation speed of the high-pressure electric motor M2 is controlled to be lowered.

If the rotation speeds of the low-pressure electric motor M1 and the high-pressure electric motor M2 are controlled as described above, hydraulic pressures and flow amounts of the low pressure portion 104 and the high pressure portion 108 can be controlled optimally. In addition, flow margin can be set by setting size and target hydraulic pressure of the orifice OR. Therefore, responsiveness of the hydraulic pumps 102 and 106 may be improved.

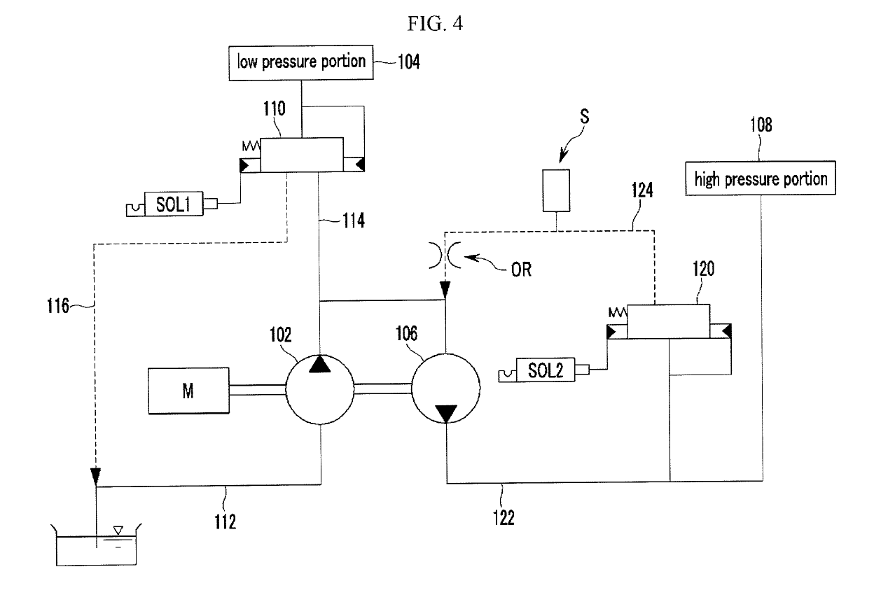

FIG. 4 is a schematic diagram of a hydraulic pressure supply system of an automatic transmission according to various embodiments of the present invention.

Referring to FIG. 4, the low-pressure hydraulic pump 102 and the high-pressure hydraulic pump 106 are driven by the independent electric motors M1 and M2 in the supply system of FIG. 2, but the low-pressure hydraulic pump 102 and the high-pressure hydraulic pump 106 are connected by one shaft and are driven by one electric motor M.

Since functions of the supply system of FIG. 4 are the same as those of that shown in FIG. 2 except using one electric motor M, detailed description thereof will be omitted.

Various embodiments of the present invention can stabilize flow amount of the second recirculation line by mounting the orifice on the second recirculation line in the hydraulic pressure supply system of an automatic transmission in which two hydraulic pumps driven by the electric motor are used. In addition, since the pressure sensor is mounted on the second recirculation line and detects the stable hydraulic pressure and the electric motors are controlled according to the detected hydraulic pressure, hydraulic pressure and flow amount at the high pressure portion and the low pressure portion may be optimized and control responsiveness may be improved.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A hydraulic pressure supply system of an automatic transmission for a vehicle comprising:
a low-pressure hydraulic pump receiving oil stored in an oil pan through an input line, generating low hydraulic pressure using the oil, and supplying the low hydraulic pressure to a low pressure portion through a low-pressure line;
a high-pressure hydraulic pump increasing a portion of the low hydraulic pressure to high hydraulic pressure and supplying the high hydraulic pressure to a high pressure portion through a high-pressure line;
a low-pressure regulator valve controlled by a first control pressure of a first solenoid valve, and recirculating a portion of the hydraulic pressure supplied through the low-pressure line to the input line through a first recirculation line so as to control the hydraulic pressure;
a high-pressure regulator valve controlled by a second control pressure of a second solenoid valve, and recirculating a portion of the hydraulic pressure supplied through the high-pressure line to the low-pressure line through a second recirculation line to control the hydraulic pressure;
an orifice disposed on the second recirculation line;
a pressure sensor disposed on the second recirculation line and detecting hydraulic pressure; and
a transmission control unit controlling at least one electric motor driving the low-pressure hydraulic pump and the high-pressure hydraulic pump according to information detected by the pressure sensor.

2. The hydraulic pressure supply system of claim 1, wherein the pressure sensor is between the orifice and the high-pressure regulator valve.

3. The hydraulic pressure supply system of claim 1, wherein a low-pressure electric motor driving the low-pressure hydraulic pump and a high-pressure electric motor driving the high-pressure hydraulic pump are provided independently.

4. The hydraulic pressure supply system of claim 1, wherein the electric motor drives the low-pressure hydraulic pump and the high-pressure hydraulic pump connected by one shaft simultaneously.

5. A hydraulic pressure supply system of an automatic transmission for a vehicle which generates low hydraulic pressure and high hydraulic pressure using oil stored in an oil pan and supplies the low hydraulic pressure and the high hydraulic pressure respectively to a low pressure portion and a high pressure portion, the hydraulic pressure supply system comprising:
a low-pressure hydraulic pump receiving the oil stored in the oil pan through an input line, generating the low hydraulic pressure, discharging the generated low hydraulic pressure to a low-pressure line;
a low-pressure regulator valve controlled by a first control pressure of a first solenoid valve, recirculating a portion of the hydraulic pressure supplied through the low-pressure line to the input line through a first recirculation line to control the hydraulic pressure, and supplying the controlled hydraulic pressure to the low pressure portion;
a high-pressure hydraulic pump increasing a portion of the hydraulic pressure supplied through the low-pressure line and discharging the high hydraulic pressure to a high-pressure line;
a high-pressure regulator valve controlled by a second control pressure of a second solenoid valve, recirculating a portion of the hydraulic pressure supplied through the high-pressure line to the low-pressure line through a second recirculation line to control the hydraulic pressure, and supplying the controlled hydraulic pressure to the high pressure portion;
an orifice disposed on the second recirculation line;
a pressure sensor disposed on the second recirculation line between the orifice and the high-pressure regulator valve;
a low-pressure electric motor driving the low-pressure hydraulic pump according to information detected by the pressure sensor; and
a high-pressure electric motor driving the high-pressure hydraulic pump according to information detected by the pressure sensor.

6. A hydraulic pressure supply system of an automatic transmission for a vehicle which generates low hydraulic pressure and high hydraulic pressure using oil stored in an oil pan and supplies the low hydraulic pressure and the high hydraulic pressure respectively to a low pressure portion and a high pressure portion, the hydraulic pressure supply system comprising:
a low-pressure hydraulic pump receiving the oil stored in the oil pan through an input line, generating the low hydraulic pressure, discharging the generated low hydraulic pressure to a low-pressure line;
a low-pressure regulator valve controlled by a first control pressure of a first solenoid valve, recirculating a portion of the hydraulic pressure supplied through the low-pressure line to the input line through a first recirculation line to control the hydraulic pressure, and supplying the controlled hydraulic pressure to the low pressure portion;
a high-pressure hydraulic pump increasing a portion of the hydraulic pressure supplied through the low-pressure line and discharging the high hydraulic pressure to a high-pressure line;
a high-pressure regulator valve controlled by a second control pressure of a second solenoid valve, recirculating a portion of the hydraulic pressure supplied through the high-pressure line to the low-pressure line through a second recirculation line to control the hydraulic pressure, and supplying the controlled hydraulic pressure to the high pressure portion;
an orifice disposed on the second recirculation line;
a pressure sensor disposed on the second recirculation line between the orifice and the high-pressure regulator valve; and
an electric motor driving the low-pressure hydraulic pump and the high-pressure hydraulic pump according to information detected by the pressure sensor simultaneously.
